(19) United States
(12) Patent Application Publication
(10) Pub. No.: US 2006/0260540 A1
(43) Pub. Date: Nov. 23, 2006

(54) Positioning element for adjusting the operating width of a metering gap

(76) Inventors: Waldemar Kiener, Lauchheim (DE); Johann Rein, Bopfingen (DE)

Correspondence Address: KRIEGSMAN & KRIEGSMAN, 30 TURNPIKE ROAD, SUITE 9, SOUTHBOROUGH, MA, 01772, US

(21) Appl. No.: 10/570,522

(22) PCT Filed: Sep. 2, 2004
(86) PCT No.: PCT/EP04/09746

§ 371 Date: Mar. 2, 2006

(30) Foreign Application Priority Data
Sep. 2, 2003 (DE) 103-40-768.5

(51) Int. Cl. B05B 15/04

(52) U.S. Cl. 118/301; 239/568

(57) ABSTRACT

The invention relates to a positioning element for adjusting the operating width of a metering gap (34) in a device (11) for applying flowable medium. Said positioning element comprises a cylindrical hollow member (58) that is closed at an end located on the driven side. At least one continuous bore (59) that forms a passage (61) between the at least one distribution channel (31) and the metering gap (34) is provided inside the cylindrical hollow member (58) while at least one sleeve section (54) which is embodied as a sealing and gliding element and surrounds the at least one continuous bore (59) or a group of continuous bores (59) is mounted on said cylindrical hollow member (58).

The invention relates to a positioning element for adjusting the operating width of a metering gap in a device for applying flowable medium according to the precharacterizing clause of claim 1.

Positioning elements of this type are used in devices for the flowable application of a hotmelt adhesive to a material web. This device comprises a coating head with a slot nozzle arrangement to discharge the adhesive. Provided in the coating head is a central distribution channel, through which the adhesive is fed via a metering gap to a slot nozzle arrangement. To adjust the operating width of the slot nozzle arrangement, at least one positioning element is provided in the distribution channel, arranged in such a way that it can at least be radially turned in the distribution channel. Provided axially spaced apart from one another in the positioning element are slotted-hole bores, which, dependent on the rotation, form a passage of different sizes between the distribution channel and the metering gap. As a result, the amount of adhesive which reaches the slot nozzle arrangement can be determined.

To seal the at least radially movable positioning element in the housing of the device, it is known to provide O-ring seals, in order to prevent the adhesive from emerging at the sides.

This arrangement of a sealing ring for sealing the distribution channel and for rotatably receiving the positioning element in the distribution channel has the disadvantage that this sealing arrangement is subjected to a high degree of wear as a result of the high temperatures of the hotmelt adhesive and the positioning movements of the positioning element.

The invention is therefore based on the object of proposing a positioning element with which it is possible for it to be arranged and received in a housing for applying flowable medium with little wear and in a sealed manner, in particular for adjusting the operating width.

This object is achieved according to the invention by the features of claim 1.

The arrangement of at least one sleeve section on the cylindrical hollow member, which is movably provided in a distribution channel of a device for discharging flowable medium, makes it possible for a sealing and gliding effect to be achieved by the sleeve section. The sleeve section surrounds the at least one passage in the cylindrical hollow member and bears directly against a wall of the distribution channel. This has the result on the one hand of providing support and guidance for the cylindrical hollow member in the distribution channel and on the other hand of creating a sealing arrangement, since the sleeve section completely surrounds the positionally adjustable passage. Consequently, a long-lasting and durable arrangement and mounting are obtained, while at the same time good guidance of the positioning element in the housing is made possible.

According to an advantageous refinement of the invention, it is provided that at least one sleeve portion is fastened on the cylindrical hollow member by a press fit. As a result, simple and low-cost production is made possible. For positioning on the cylindrical hollow member, the sleeve section is preferably heated up, so that a widening in diameter is obtained, in order to make it easy to fit the sleeve section onto the cylindrical hollow member. This advantageous arrangement also has the advantage that, when there are instances of damage or wear, the sleeve section can be exchanged. Furthermore, different sleeve sections, which are for example adapted to the different adhesive substances, can be fitted onto one and the same cylindrical hollow member.

According to a further advantageous refinement of the invention, it is provided that, to increase the holding force, the cylindrical hollow member has at least one knurled, embossed or longitudinally grooved surface. The knurled surface allows an increased surface area to be achieved on the hollow cylinder, whereby a non-positive and positive connection is created after fitting the at least one sleeve section and achieving a press fit. The same applies to a longitudinally grooved surface. The longitudinally grooved surface additionally has the advantage that it is made easier for the sleeve section to be pushed on in the heated-up state for assembly.

According to a further advantageous refinement of the invention, provided between the first sleeve section and at least one further sleeve section is a ring section, which is formed with a smaller outside diameter than the sleeve section or sections. This allows the frictional forces acting between the distribution channel and the positioning element to be reduced, whereby a quicker and more exact positioning movement of the positioning element by means of a drive is made possible. Furthermore, the driving forces are reduced.

A further preferred embodiment of the invention provides that at least one sleeve section and a ring section are integrally connected to one another. This allows the formation of individual assembly groups, which have one or more passages in the sleeve section and can be accommodated on the cylindrical hollow member in the desired sequence. This also results in simple assembly.

Furthermore, it is advantageously provided that an expansion gap is provided between at least one ring section and at least one sleeve section or between at least two assembly groups assigned to one another, which are formed by at least one sleeve section and a ring section. This ensures that the sleeve and ring sections or assembly groups can be positioned on the hollow member in a stress-free manner and linear expansions can be compensated, since during the discharge of the adhesive the space inside the positioning element is exposed to heated adhesive.

Furthermore, it is advantageously provided that the passage or passages of each sleeve section are produced after the positioning of the at least one sleeve section on the hollow member. This makes production easier. A radial alignment of the sleeve sections in relation to already existing apertures in the hollow member is not required. These are made together, after the sleeve section is fitted. This allows an exact alignment and positioning of the apertures in the positioning element to be obtained.

The longitudinal axes of the apertures are preferably aligned off-center in relation to the center point of the hollow member. The passage provided first is preferably arranged virtually tangentially in relation to an inside diameter of the cylindrical hollow member, so that emergence of the adhesive in a way conducive to flow is made possible. If one or more further passages are arranged, they advantageously respectively adjoin the wall of the previous passage, the longitudinal axis of which being formed in such a way that the passages run together, at least in the region of the wall thickness.

According to a further advantageous refinement of the invention, it is provided that the sleeve section is produced from at least one composite material with gliding and sealing properties. The proportions and composition of the composite material may be variously provided. For example, a base substance of Teflon which is enriched with bronze or the like may be provided. Further material combinations that are heat-resistant, have good bearing properties and also assume a sealing function are possible.

The invention and further advantageous embodiments and developments of the same are described and explained in more detail below on the basis of the example represented in the drawing. The features that can be taken from the description and the drawing may be used according to the invention individually in themselves or more than one together in any combination. In the drawing:

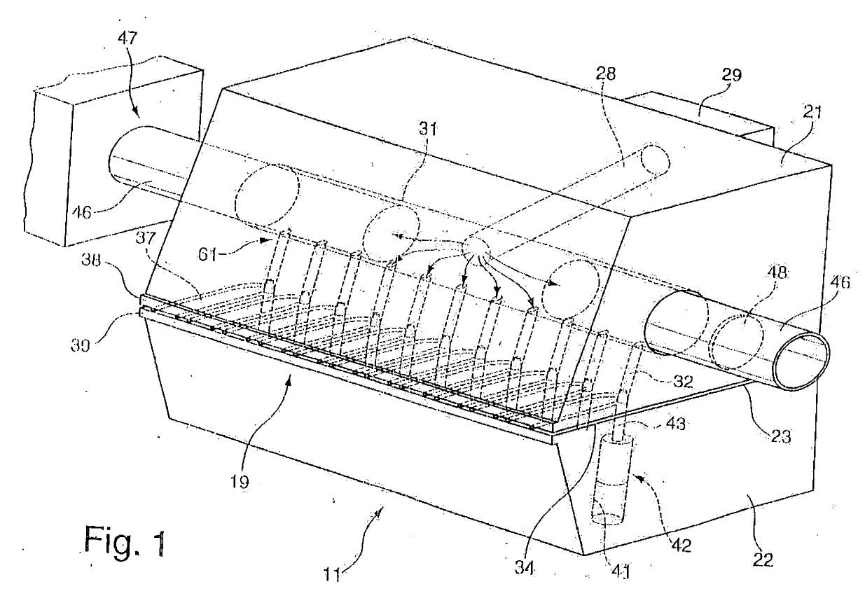

FIG. 1 shows a perspective view of a device for applying flowable medium,

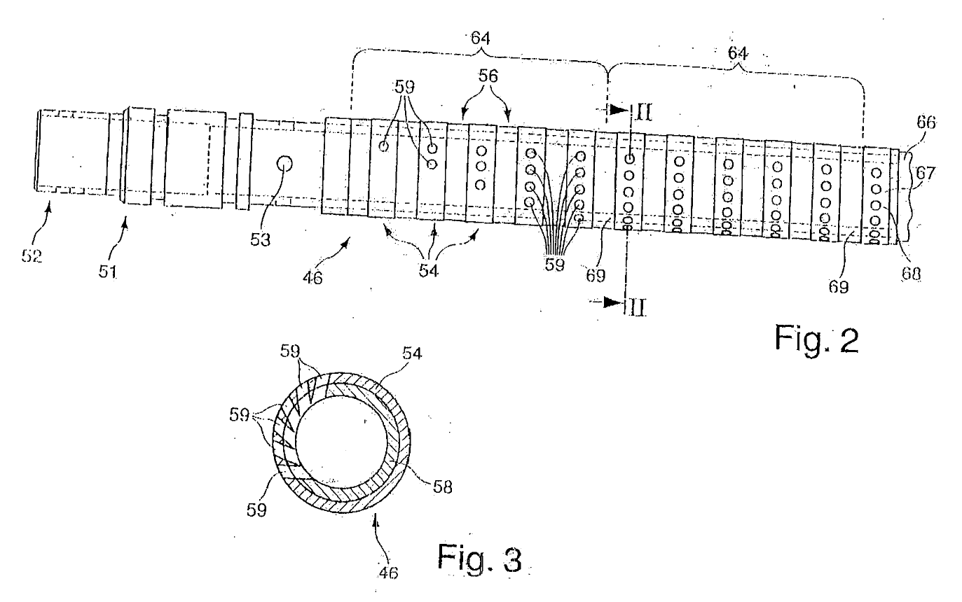

FIG. 2 shows a schematic side view of a positioning element according to the invention and

FIG. 3 shows a schematic sectional representation along the line II-II in FIG. 2.

In FIG. 1, a device 11 for applying a flowable medium to a material web (not represented any more specifically) is perspectively represented.

The expression “material web” is to be understood in a broad sense. It may comprise both woven and non-woven structures. Similarly, they may be breathable materials or else sheets of plastic or paper. In addition, the material web may already be coated or pretreated or be a one-, two- or multi-layer composite of different components or coatings or materials. Furthermore, it may be provided that a one-ply or multi-ply material has one or more coatings of the flowable material applied to it, in order for example to seal a material web or provide it with a specific breathable layer.

The expression “flowable medium” is likewise to be understood in a broad sense. It includes thermoplastic adhesives, thermoplastic resins, reactive adhesives, such as POR for example, high-performance adhesives and adhesives which have a softening point or melting point of, for example, over 180°. Similarly, further high- or low-viscosity flowable fluids or media that can be applied hot and/or cold by the device to the material web may be provided. The flowable medium may similarly have fibrous additives or other additions that can be processed by the device according to the invention.

The device 11 is a so-called coating head, which has a nozzle arrangement 19, in particular a wide-slot nozzle arrangement. The device 11 comprises a first and second or upper and lower housing section 21, 22, the upper housing section 21 advantageously being removable along a separating plane 23 from the lower housing section 22, preferably for cleaning. Provided in the housing sections 21, 22 are bores 24, in which controllable heating elements are arranged. Provided in the upper housing section 21 is a feed channel 28, to which a pump unit 29 is connected. The flowable medium is fed to the device 11 by means of this pump unit 29. The pump unit 29 may comprise metering pumps and a buffer tank, a melt unit or the like, in order to provide the flowable medium in a suitable way and feed it to the feed channel 28. The channel 28 opens out into a distribution channel 31, which preferably extends parallel to the slot nozzle arrangement 19 over the entire width of the housing section 21. From the distribution channel 31, supply channels 32 lead into a metering gap 34, which lies for example in the separating plane 23. Arranged in the metering gap 34 is a template 36, which has segmental channels 37. The segmental channels 37 are formed for example in a bell-shaped, V-shaped or U-shaped manner. The supply channels 32 preferably open out completely into the segmental channels 37. Dependent on the flowable medium to be processed, the template 36 may be correspondingly formed in thickness and geometry to apply a desired mass of flowable medium. The template 36 is exchangeably arranged in the metering gap 34. The metering gap 34 has at its outer end an upper and a lower discharge lip 38, 39 and forms a so-called pinch-off face and at the same time guides the web material tangentially along on its outer side.

Provided in the lower housing section 22 are bores 41 for receiving valves 42, which serve for controlling the flow rate of the medium from the supply channel 32 into the segmental channel 37. The valves 42 have an adjustable needle 43 with a cone-like or conical tip, which can be positioned in the supply channel 32. The variable adjustment of the valves 42 makes it possible to set a flow rate that is the same for all the supply channels 32 as a basic adjustment. Alternatively, it may be provided that these valves 42 can be used and likewise can be activated by means of an additional connecting and disconnecting means for the adjustment of the operating width of a metering gap 34.

Arranged in the distribution channel 31 is a positioning element 46 of an adjusting unit 47, which can be moved axially and/or radially in the distribution channel 31. The positioning element 46 is formed in a tubular manner and has an open end toward the center of the nozzle arrangement 19. Toward the outer edge region of the housing section 21, the positioning element is closed by a closure element 48 or a closure plug.

The positioning element 46 is schematically represented in FIG. 2. Provided at a left-hand end is a flange 51 and a receptacle 52, by which the positioning element 46 is exchangeably received and activated by means of the adjusting unit 47. Provided alongside the flange 51 is a bore 53, which, as an adjusting aid, makes it possible for the positioning element 46 to be radially aligned exactly in the distribution channel 31 or the supply channels 32. A section that enters the distribution channel 31 comprises a multiplicity of sleeve sections 54 and ring sections 56, which according to the exemplary embodiment in FIG. 2 are arranged alternating with one another on the cylindrical hollow member 58. The positioning element 46 has, assigned to the outer housing section 22, a first sleeve section 54, which comprises a through hole 59, which forms a passage 61 between the distribution channel 31 or the space inside the hollow member 58 and a supply channel 32. Provided adjacent the first sleeve section 54 is a ring section 56. This ring section 56 is formed in such a way that it is smaller in outside diameter than the sleeve section 54. This ring section 56 is in turn adjoined by a second sleeve section 54, which comprises for example two through holes 59. The first through hole 59 of the second sleeve section 54 is arranged at a first radial position 66. The second through hole 59 of the second sleeve section 54 is arranged at a radial position 67. A third through hole 59 on the third sleeve section 54 is arranged at a third radial position 68, and so on. It is made possible in this way that, in an adjustment in which the radial alignment 66 is in line with the distribution channels 32, a maximum discharge or a maximum feed of adhesive to the metering gap 34 takes place. Turning of the positioning element 46 allows a step-by-step adjustment to be made possible, the application width of the adhesive decreasing from the outside inward as a result of the adjustable radial position of the positioning element 46. A further position is also a closing position, in which the passages 61 are closed and no adhesive is fed to the distribution channels 32.

The arrangement of the through holes 59 is represented for example in FIG. 3, which corresponds to a sectional representation along the line II-II in FIG. 2. The first through hole 59 runs substantially tangentially in relation to the space inside the hollow member 58. The second through hole 59 is arranged at an angle to the first through hole 59, so that within the wall thickness of the hollow member 38 the bores at least partially intersect or are adjacent one another. The further through holes 59 that are provided are formed analogously.

The sleeve section 54 is heated for the positioning on the hollow member 58, so that the inside diameter of the sleeve section 54 is increased in comparison with the outside diameter of the hollow member 58. After cooling down, the sleeve section 54 is fastened on the hollow member 58, preferably by means of a press fit.

To increase the adhesion between the sleeve section 54, the ring section 54 and/or the assembly group 64 and the hollow member 58, a knurling may be provided on the hollow member 58. Furthermore, a grooving running along the longitudinal axis or a rhombic grooving or the like may be provided. Similarly, it may be provided that a heat-resistant adhesive is introduced between the sleeve section 54 and the hollow member 58 in order to secure the press fit.

According to a first advantageous embodiment, the sleeve section 54 is formed as an annular element, which is formed in such a way that it is at least slightly wider than the diameter of a through hole 59. The ring section 56 is likewise formed in an annular manner as a single element and, by analogy with the sleeve section 54, can be fixed on the cylindrical hollow member 58. The ring section 56 serves substantially for spacing apart two sleeve sections 54 arranged in relation to one another. The reduced outside diameter of the ring section 56 with respect to the sleeve section 54 makes it possible to reduce the driving force as a result of a reduced frictional surface area. The at least one ring section 56 may optionally be provided between two sleeve sections 54.

According to an advantageous embodiment, it is provided that a assembly group 64 is formed, comprising a number of sleeve sections 54 and ring sections 56. In the exemplary embodiment according to FIG. 2, two assembly groups 64 are represented, the two assembly groups 64 being arranged in relation to one another in their transitional region by an expansion gap 69 or a spacing 69. The assembly group 64 is formed as a cylindrical member. The outside diameters of the sleeve sections 54 and of the ring sections 56 and also the width of the sleeve sections 54 and ring sections 56 can be fixed by machining on a lathe. The width of the ring sections 56 is dependent on the spacing of the distribution channels 32 and the size of the distribution channels 32. The sleeve section 54 completely surrounds the through hole 59, the through hole 59 being formed in such a way that it is smaller than or the same size as the diameter of the distribution channel 32.

The outside diameter of the sleeve section 54 is adapted to the size of the distribution channel 31, so that rotation is made possible for adjusting the positioning element 46, but at the same time a sealing arrangement is provided between the through hole 51 and the adjacent wall section of the distribution channel 31.

In the case of the embodiment represented in FIG. 2, the through holes 56 are preferably made after fitting the assembly group 64 or individual sleeve sections 54 and ring sections 56 and interposed ring sections 56.

According to an alternative refinement of the invention, it may be provided that a member which corresponds to a assembly group 64 is inserted in the distribution channel 31. This member is inserted in the distribution channel 31 for example in a greatly cooled-down state, and forms a press fit with respect to the distribution channel 31. The positioning element 46 is formed as a hollow member 58 and is inserted and guided in the assembly group 64 inserted and pressed into the distribution channel. This allows the effect described above to be achieved, according to which there is at least one drive with low frictional forces and through holes 59 in a not-in-use position seal the passage or passages 61.

1. A positioning element for adjusting the operating width of a metering gap in a device for applying flowable medium, with a hollow member, which is closed at an end on the drive side and has in the cylindrical hollow member at least one through hole, which forms a passage between the at least one distribution channel and the metering gap, wherein at least one sleeve section is provided on the cylindrical hollow member, which is formed as a sealing and gliding element and surrounds at least one through hole or a group of through holes.

2. The positioning element as claimed in claim 1, wherein the at least one sleeve section is fastened on the cylindrical hollow member by a press fit.

3. The positioning element as claimed in claim 1, wherein, to increase the holding force with respect to the at least one sleeve section, the cylindrical hollow member has at least one knurled or longitudinally grooved or embossed surface.

4. The positioning element as claimed in claim 1, wherein at least one ring section is provided between a first and a further sleeve section, which is formed with a smaller outside diameter than the sleeve section or sections.

5. The positioning element as claimed in claim 1, wherein at least one sleeve section and a ring section are integrally connected to one another and form a assembly group.

6. The positioning element as claimed in claim 1, wherein an expansion joint is formed between a ring section and a sleeve section or between two subassembly groups assigned to one another.

7. The positioning element as claimed in claim 1, wherein the through hole or holes of each sleeve section are produced after the positioning of the sleeve section on the cylindrical hollow member.

8. The positioning element as claimed in claim 1, wherein a longitudinal axis of the at least one through hole runs off-center in relation to the center point of the hollow member.

9. The positioning element as claimed in claim 1, wherein a longitudinal axis of the further through hole is radially inclined in relation to the longitudinal axis of the previous through hole and is arranged outside the center point of the hollow member.

10. The positioning element as claimed in claim 1, wherein the sleeve section at least is formed from a composite material with gliding or sealing properties.
